(19) United States
(12) Patent Application Publication
(10) Pub. No.: US 2009/0052945 A1
(43) Pub. Date: Feb. 26, 2009

(54) IMAGE FORMING APPARATUS

(75) Inventor: Takashi Shiraishi, Kawasaki-shi (JP)

Correspondence Address: AMIN, TUROCY & CALVIN, LLP, 127 Public Square, 57th Floor, Key Tower, CLEVELAND, OH, 44114, US

(73) Assignees: Kabushiki Kaisha Toshiba, Tokyo (JP); Toshiba Tec Kabushiki Kaisha, Tokyo (JP)

(21) Appl. No.: 11/456,336

(22) Filed: Jul. 10, 2006

(51) Int. Cl. G03G 15/043

(52) U.S. Cl. 399/221

(57) ABSTRACT

By using an embodiment of the invention, an image forming apparatus capable of reducing time required until a monochromatic image output frequently used for image formation is outputted, having the number of output sheets per unit time in outputting a color image equivalent to that in the output of the monochromatic image, and capable of securing durability for an exposing system used for the output of the monochromatic image frequently used for image formation equivalent to that of an exposing system for the color image is obtained.

### BACKGROUND OF THE INVENTION

1. Field of the Invention

The present invention relates to an image forming apparatus represented by, for example, an electrostatic copying machine and a laser beam printer, and, more particularly to a color image forming apparatus capable of providing a color image on the basis of a subtractive process.

2. Description of the Related Art

A color image forming apparatus capable of providing a color image on the basis of a subtractive process has already been put to practical use and widely used.

In Japanese Patent Disclosure (KOKAI) NO. 2005-221870, an image forming apparatus including an exposing unit having one deflector that provides image lights of respective colors of Black (BK), Yellow (Y), Magenta (M), and Cyan (C) and a one set of imaging optical systems and four developing units that develop latent images of the respective colors is described.

In Japanese Patent Disclosure (KOKAI) No. 2003-266781, an image forming apparatus in which exposing units and image forming units independently provided for respective colors of Black (BK), Yellow (Y), Magenta (M), and Cyan (C) are arranged in one row along a transfer belt is described.

In Japanese Patent Disclosure (KOKAI) No. 2005-181714, an image forming apparatus in which image light of Black (BK) and image light of one color among Yellow (Y), Magenta (M), and Cyan (C) are provided by an identical exposing unit and an exposing unit for the remaining two colors among Yellow (Y), Magenta (M), and Cyan (C) is independently provided as a second exposing unit is described.

In Japanese Patent Disclosure (KOKAI) No. H4-284468, an image forming apparatus in which an exposing unit and an image forming unit dedicated for Black (BK) and exposing units and image forming units for respective colors of Yellow (Y), Magenta (M), and Cyan (C) are arranged in one row along a transfer belt is described.

However, in the image forming apparatus described in 2005-221870, since an increase in thickness of a mirror of the deflector is required, a motor for rotating the mirror is increased in size. Further, a windage loss tends to occur and the image forming apparatus is expensive because of the thickness of the mirror.

In the image forming apparatus described in 2003-266781, since the exposing units of the respective colors are arranged independently, an exposing system occupies a large portion (in the image forming apparatus) and a size of the image forming apparatus is also increased. When images (toner images) of the respective colors are superimposed one on top of another, it is inevitable that color drift occurs because of individual differences of the respective exposing units.

In the image forming apparatus described in 2005-181714, it is inevitable that color drift occurs between one of Yellow (Y), Magenta (M), and Cyan (C) and the remaining two colors because of individual differences of the two exposing units.

In the image forming apparatus described in H4-284468, at the time of image formation in which the exposing units and the image forming units for the three colors of Yellow (Y), Magenta (M), and Cyan (C) are used, since image formation is required to be performed three times, output speed of a color image, that is, the number of output sheets/unit time falls.

### BRIEF SUMMARY OF THE INVENTION

It is an object of the invention to provide an image forming apparatus capable of reducing time required until a monochromatic image frequently used for image formation is outputted, having the number of output sheets per unit time in outputting a color image equivalent to that in the output of the monochromatic image, and capable of securing durability for an exposing system used for the output of the monochromatic image frequently used for image formation equivalent to that of an exposing system for the color image.

The invention provides an image forming apparatus comprising:

a first toner image generating unit that generates a latent image corresponding to first image light supplied in association with one of color components;

a second toner image generating unit that generates a latent image corresponding to second image light supplied in association with one of the color components different from the first image light supplied to the first toner image generating unit;

a third toner image generating unit that generates a latent image corresponding to third image light supplied in association with one of the color components different from the first and the second image lights supplied to the first toner image generating unit and the second toner image generating unit;

a first exposing unit that continuously deflects the first image light in one direction toward the first toner image generating unit;

a second exposing unit that continuously deflects the second image light and the third image light in one direction toward the second toner image generating unit and the third toner image generating unit;

a first developing unit that visualizes, with a toner of a first color, a latent image formed on the first toner image generating unit by the first image light deflected by the first exposing unit;

a second developing unit that visualizes, with a toner of a second color, a latent image formed on the second toner image generating unit by the second image light deflected by the second exposing unit; and

a third developing unit that visualizes, with a toner of a third color, a latent image formed on the third toner image generating unit by the third image light deflected by the second exposing unit.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing an example of an image forming apparatus to which an embodiment of the invention is applied;

FIGS. 2 and 3 are schematic diagrams showing an example of a first exposing unit built in the image forming apparatus shown in FIG. 1 (FIG. 2 shows a state in which image light deflected by a deflecting unit is cut in a position where an optical path length of the image light is the smallest; and FIG. 3 shows a state in which image light is deflected by the deflecting unit);

FIG. 4 is a schematic diagram showing an example of a mechanism for compensating for scanning line bending applied to the exposing unit shown in FIGS. 2 and 3;

FIGS. 5 and 6 are schematic diagrams showing an example of a second exposing unit built in the image forming apparatus shown in FIG. 1 (FIG. 5 shows a state in which image light deflected by the deflecting unit is cut in a position where an optical path length of the image light is the smallest; and FIG. 6 shows a state in which the image light is deflected by the deflecting unit); and

FIG. 7 is a schematic diagram for explaining a relation between spatial frequencies of a BK (monochromatic) image output and a color image output in a color image outputted by the image forming apparatus shown in FIG. 1 and response of perception of eyes (of a human, that is, a user).

### DETAILED DESCRIPTION OF THE INVENTION

An embodiment of the invention will be hereinafter explained with reference to the drawings.

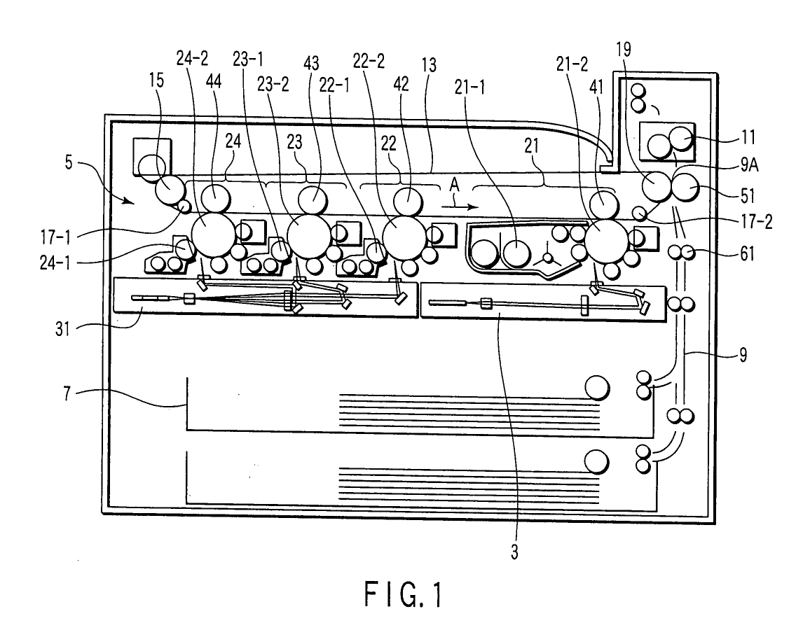

FIG. 1 shows an example of an image forming apparatus including an optical scanning unit (an exposing unit) to which the embodiment of the invention is applied. In the explanation of the embodiment, an example of the invention will be explained with a color printer apparatus as an example. However, it goes without saying that the invention is applicable to an arbitrary apparatus (capable of outputting an image) such as a full-color copying apparatus, a facsimile apparatus, or a workstation apparatus.

The image forming apparatus, that is, a color printer apparatus 1 includes an exposing unit 3 that generates image light corresponding to a monochromatic image signal (e.g., black, BK) frequently used for image formation, an exposing unit 31 that generates image lights corresponding to image signals of respective colors of Yellow (Y), Magenta (M), and Cyan (C) other than BK based on a subtractive process, and an image forming unit 5 that transfers, on the basis of image lights supplied by the exposing unit 3 and the exposing unit 31, a toner image visualized by a developing agent, that is, a toner onto a transfer medium, that is, sheet-like paper P used for an output (output paper) called hard copy or print out and outputs the output.

Paper is provided to the image forming unit 5, every time a toner image is formed, from a paper holding unit 7 capable of holding an arbitrary number of pieces of the sheet-like paper P of a predetermined size and providing the paper P one by one according to timing when the toner image is formed in the image forming unit 5.

A conveyance path 9 that guides the paper P from the paper holding unit 7 toward the image forming unit 5 is provided between the paper holding unit 7 and the image forming unit 5. The conveyance path 9 guides the paper P to a fixing unit 11, which fixes a toner image transferred onto the paper P on the paper P as explained later, through a transfer position 9A where a toner image formed in the image forming unit 5 is transferred as explained later. The conveyance path 9 also functions as a paper passage that guides the paper P having the toner image fixed thereon by the fixing unit 11 to an image output holding unit 1a also serving as a part of a cover over the image forming unit 5.

The image forming unit 5 has an intermediate transfer belt 13 obtained by forming, for example, an insulative film of predetermined thickness in an endless belt shape. A belt obtained by forming metal in a thin sheet shape and protecting the surface of the metal with resin or the like can also be used as the intermediate transfer belt 13.

Predetermined tension is given to the intermediate transfer belt 13 by a driving roller 15, a first tension roller 17-1 and a second tension roller 17-2, and a transfer roller 19. When the driving roller 15 is rotated, an arbitrary position parallel to an axis of the driving roller 15 is moved in a direction of an arrow A. In other words, a belt surface of the intermediate transfer belt 13 is turned in one direction at speed at which the outer peripheral surface of the driving roller 15 is moved.

First, second, third, and fourth image forming units 21, 22, 23, and 24 are arranged at predetermined intervals in a section where the belt surface of the intermediate transfer belt 13 is moved substantially flatly in a state in which the predetermined tension is given to the intermediate transfer belt 13 by the respective rollers. In the example shown in FIG. 1, the first image forming unit 21 is located on the side of the second tension roller 17-2 and the fourth image forming unit 24 is located on the side of the first tension roller 17-1 in a section where the belt surface of the intermediate transfer belt 13 is moved substantially flatly between the first tension roller 17-1 and the second tension roller 17-2.

The first image forming unit 21 includes at least a developing unit 21-1 in which a toner of a BK (black) color is stored and a photosensitive drum 21-2 that holds an electrostatic image that the developing unit 21-1 should develop. In other words, an electrostatic image (a latent image) corresponding to an image of a color that a developing unit set in the image forming unit should develop is formed on the surface (the outer peripheral surface) of the photosensitive drum of the image forming unit 21 by image light from the exposing unit 3. Consequently, the toner is selectively supplied (to the latent image) by the developing unit 21-1. As a result, a developing agent image of BK, that is, a BK toner image is formed on the photosensitive drum 21-2.

The second to the fourth image forming units 22 to 24 include at least developing units 22-1, 23-1, and 24-1 in which toners of arbitrary colors of C (Cyan), M (Magenta), and Y (Yellow) are stored and photosensitive drums 22-2, 23-2, and 24-2 that hold electrostatic images that the respective developing units should develop. Electrostatic images (latent images) corresponding to images of colors that the developing units set in the image forming units should develop are formed on the surfaces (the outer peripheral surfaces) of photosensitive drums of the respective image forming units by image light from the exposing unit 31. Consequently, the toners are selectively supplied (to the latent images) by the developing units corresponding to the toners. As a result, a developing agent image of a color defined in advance, that is, a toner image of any one of C, M, and Y is formed on each of the photosensitive drums. A combination of colors of (toners) allocated to the second to the fourth image forming units 22 to 24 (an order of arrangement of the units) is arbitrary.

Primary transfer units (transfer rollers) 41 to 44 for transferring toner images held by the respective photosensitive drums to the intermediate transfer belt 13 are provided in positions opposed to the respective photosensitive drums on the rear surface side of the intermediate transfer belt 13 in a state in which the intermediate transfer belt 13 is interposed between the respective photosensitive drums and the respective first to fourth image forming units 21 to 24.

In the printer apparatus 1 in which the developing units 21-1, 22-1, 23-1, and 24-1, the photosensitive drums 21-2, 22-2, 23-2, and 24-2, the transfer rollers 41 to 44, and the intermediate transfer roller 13 are arranged as described above, image lights, which are generated when image signals supplied by a not-shown image signal supplying unit are supplied to the exposing unit 3 and the exposing unit 31 for each of the color components, are irradiated on the surfaces of the photosensitive drums integral with the developing units, which hold toners of the corresponding colors, and exposure of the surfaces is performed.

In this case, in the respective image forming units 21 to 24, electrostatic latent images are formed at predetermined timing and developed (visualized) by the developing units corresponding thereto such that toner images that are (should be) sequentially transferred to the intermediate transfer belt 13 are superimposed one on top of another on the intermediate transfer belt 13.

Toner images formed on the photosensitive drums 21-2, 22-2, 23-2, and 24-2 of the respective image forming units 21 to 24 are transferred onto the intermediate transfer belt 13 by the primary transfer units 41 to 44 corresponding to the respective photosensitive drums 21-2, 22-2, 23-2, and 24-2. In this case, when the intermediate transfer belt 13 is turned (moved) at predetermined speed, toner images of Y, M, C, and BK are stacked in order on the intermediate transfer belt 13. As the primary transfer units 41 to 44, in the example in FIG. 1, roller bodies are used. However, naturally, the primary transfer units 41 to 44 may be voltage generating units such as scorotrons.

A (full-color) toner image obtained by superimposing the toner images one on top of another on the intermediate transfer belt 13 is transferred onto the paper P, which is guided to the transfer position 9A, by a transfer unit (a secondary transfer roller) 51 brought into contact with the intermediate transfer belt 13 at a predetermined pressure in the transfer position 9A of the conveyance path 9.

A registration roller 61 that temporarily stops the paper P guided from the paper holding unit 7 toward the transfer position 9A is provided in a predetermined position in the conveyance path 9 from the paper holding unit 7 to the transfer position 9A. In the registration roller 61, at least one of rollers rotates in a predetermined direction and the other roller is pressed against one roller with a predetermined pressure via a not-shown press-contact mechanism.

The paper P guided from the paper holding unit 7 toward the transfer position 9A on the conveyance path 9 is temporarily stopped by the registration roller 61. Consequently, inclination (of the paper P itself with respect to a conveyance direction), which may occur while the paper P is conveyed on the conveyance path 9 from the paper holding unit 7, is corrected.

Timing when the toner image carried toward the transfer position 9A following the movement of the belt surface of the intermediate transfer belt 13 comes to the transfer position 9A and timing when the paper P reaches the transfer position 9A are set according to timing when the registration roller 61 is rotated again, whereby a position of the toner image with respect to the paper P is managed (a position of the toner image on the paper P can be set arbitrarily).

In the printer apparatus 1 shown in FIG. 1, the BK developing units 21-1 storing the toner of BK and the photosensitive drum 21-2 (the image forming unit 21) are arranged close to a second tension roller 1b. Thus, when an image of a monochromatic BK is outputted, time from input of an image signal to the exposing unit 3 until an output is outputted is short compared with time from the use of the image forming units of the other colors until an output is outputted.

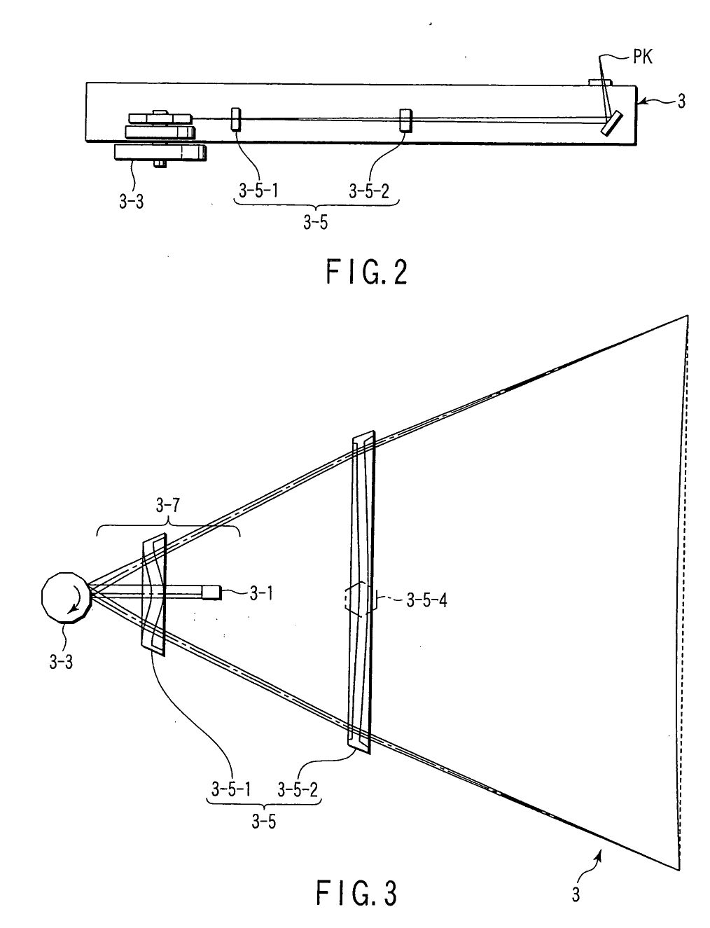

The first exposing unit 3 includes, as shown in FIGS. 2 and 3, at least a light source (a semiconductor laser element) 3-1 that outputs image light (exposure light) corresponding to BK image information used for forming a toner image in the first image forming unit 21, a deflecting unit 3-3 that associates image light from the light source 3-1 with a raster direction (hereinafter referred to as main-scanning direction) in outputting an output (output paper), an image forming optical system 3-5 that condenses image light, which is subjected to raster deflection (scanning) by the deflecting unit 3-3, on the photosensitive drum 21-1 under predetermined conditions regardless of an angle of deflection, and an exposure light shaping optical system 3-7 that guides image light from the light source 3-1 to the deflecting unit 3-3 under predetermined conditions.

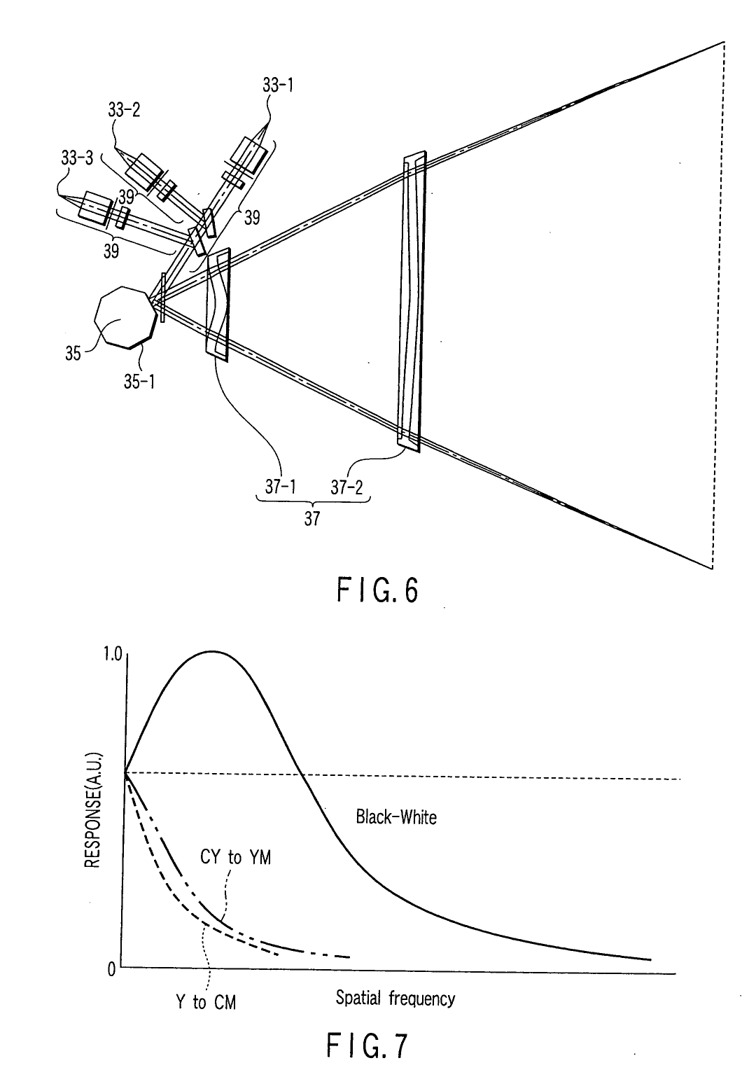

The deflecting unit 3-3 has a rotatable reflection element (this reflection element is thinner than a reflection element for three colors built in the second exposing unit 31 explained below with reference to FIGS. 5 and 6, which is fixed to a shaft of a motor). The deflecting unit 3-3 is rotated at predetermined speed (number of revolutions) for the raster scanning (deflection). The number of reflection surfaces provided in the reflection element and the number of revolutions are defined according to a request for output, that is, resolution, output speed, and the like required of the copying apparatus (the image forming apparatus) 1.

The image forming optical system 3-5 includes, in positions in longitudinal directions of the photosensitive drum 21-1, that is, in a direction perpendicular to a direction in which paper is conveyed (a direction in which the photosensitive drum is rotated), at least (long slender) lenses 3-5-1 and 3-5-2 (extending in the longitudinal directions) to which different convergent properties are given in association with positions (on the photosensitive drums) depending on an angle of deflection, which is a swing angle, of image light subjected to raster scanning by the deflecting unit 3-3 that is caused when the image light is subjected to raster deflection.

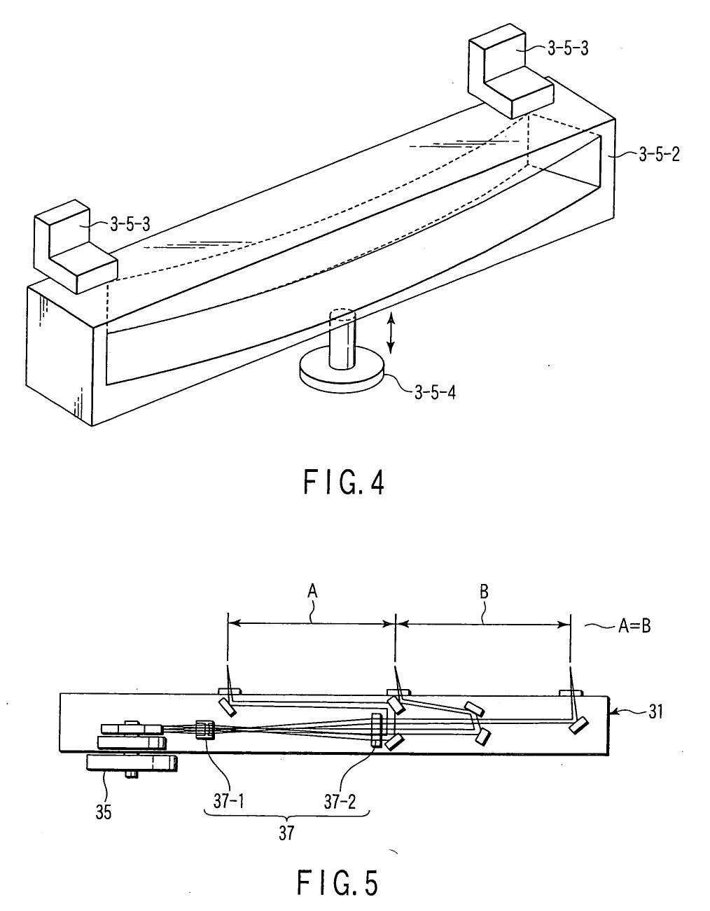

The image forming optical system 3-5 also includes various optical elements (e.g., a mirror(s) and a filter(s)) for guiding the image light subjected to raster scanning by the deflecting unit 3-3 to the photosensitive drum 21-1 of the first image forming unit 21. The lenses 3-5-1 and/or 3-5-2 may be replaced with a mirror(s) having a similar curved surface by optimizing types and shapes of the optical elements and using a combination of arrangements. In at least one of the lenses 3-5-1 and/or 3-5-2 or the mirror(s) and/or the filter(s), a scanning line along an axial direction of the photosensitive drum 22-2 (in a state in which image light is focused in the main scanning direction) is deformed by a scanning line curve compensating mechanism shown in FIG. 4 (an example of application to the lens 3-5-2 is shown in FIG. 4). Specifically, the lens 3-5-2 is deformed by rotating an adjusting mechanism (a screw, in this example) 3-5-4 shown in FIG. 4 and applying a pressure to the lens 3-5-2, both ends of which are held by a holder 3-5-3, in the center in the longitudinal direction or an arbitrary position. Consequently, a scanning line (a main scanning line) in a focus position shown in FIG. 3 is changed from a state indicated by a dotted line to a state indicated by a solid line. It goes without saying that a well-known arbitrary mechanism is applicable as the scanning line bending compensating mechanism.

The exposure light shaping optical system 3-7 shapes image light from the light source 3-1 to have a sectional beam shape satisfying predetermined conditions (to be condensed) when the image light is subjected to raster scanning by the deflecting unit 3-3 and condensed in a predetermined position in the longitudinal direction of the photosensitive drum 21-1 by the image forming optical system 3-5. The exposure light shaping optical system 3-7 includes various optical elements represented by, for example, a condenser(s), a mirror(s), and an aperture stop(s).

In the first exposing unit 3, image light to be irradiated is supplied from the exposure light shaping optical system 3-7 (the light source 3-1) to the deflecting unit 3-3 according to the well-known over-fill (over illumination) system. A size of a reflecting member 3-3-1 of the deflecting unit 3-3 is reduced by using the over-fill (over illumination) system. In the first exposing unit 3, since there are only a group of image lights for BK, it is also possible to reduce thickness and weight of a reflection surface (a rotation body). As examples of characteristics of a shape of the reflecting member 3-3-1, the number of reflection surfaces is twelve, thickness thereof is 2 mm, and a diameter of an inscribed circle thereof is 25 mm. In the over illumination system, the reflection member has the characteristics of the shape described above. Thus, the over illumination system is suitable when it is attempted to obtain an angle of deflection and a sectional beam diameter identical with those of an exposure system of three colors (C, M, and Y) like the second exposing unit 31 explained below with reference to FIGS. 5 and 6.

In the over illumination system, it is possible to increase the number of revolutions of the reflecting member 3-3-1 of the deflecting unit 3-3 without requiring an increase in size of the like of the motor. Since the size of the reflecting member 3-3-1 is reduced, it is also possible to reduce a windage loss.

This means that, in the color image forming apparatus, it is possible to reduce cost of the exposing unit (the deflecting unit) for a BK image compared with a system in which a deflecting unit used for an exposing unit for BK is also used for a deflecting unit for color, for example, a system in which a large rotating mirror is rotated at high speed by a large motor as described in Japanese Patent Disclosure (KOKAI) No. 2005-221870. On the other hand, for example, in the image forming apparatus including the exposing unit and the image forming unit dedicated for Black (BK) described in Japanese Patent Disclosure (KOKAI) No. H4-284468, it is possible to suitably design (optimize) an exposing unit (a deflecting unit) for a BK image to be associated with an image output, for example, improve durability compared with exposing units (deflecting units) for color (C, M, and Y) images less frequently outputted compared with a monochromatic BK image. It is possible to optimize the exposing units (the deflecting units) for each of the colors, for example, use an oil dynamic pressure bearing with durable time of about 5000 hours for motors of the exposing units (the deflecting units) for color (C, M, and Y) images and use an air dynamic pressure bearing with durable time of about 1 million hours for a motor of the exposing unit (the deflecting unit) for a BK (monochromatic) image. A structure and a constitution of a cooling system required for cooling of the motors and driving circuits can also be simplified (reduced in size). Moreover, time and energy (which should be supplied to the motors) required for accelerating rotation speed of the reflecting member 3-3-1 to predetermined speed are also reduced (because a moment of inertia of the reflecting member is reduced). This is also useful for reducing time from input of an image signal of a BK image until a BK image is outputted (reducing first copy time).

On the other hand, in the over illumination system, it is required to guide image light (incident light), which travels to the reflection surfaces, from generally the center of the reflection surfaces and the main scanning direction of the lens of the focusing optical system (when an angle formed by width of the image light reflected on the reflection surfaces, that is, emitted light with a normal of the reflection surfaces with respect to the incident light is α, since the image light has a characteristic proportional to cos (α), if the exposure light shaping optical system 3-7 (the light source 3-1) is located in a direction in which an angle of the normal of the reflection surfaces with respect to the incident light is substantially changed in the beginning and the end of scanning, large asymmetry occurs in a beam width and an amount of light of the emitted light). Thus, application of the over illumination system to a system for deflecting image light for three colors (C, M, and Y) on one reflection surface such as the second exposing unit 31 explained below with reference to FIGS. 5 and 6 may complicate an exposure system.

The second exposing unit 31 includes, as shown in FIGS. 5 and 6, light sources (semiconductor laser elements) 33-1 to 33-3 that output second to fourth image lights (exposure lights) corresponding to image information subjected to color separation in accordance with a subtractive process used for forming toner images in the respective second to fourth image forming units 22 to 24, a deflecting unit 35 that associates image lights from the respective light sources 33-1 to 33-3 with a raster direction (hereinafter referred to as main scanning direction) in outputting an output (output paper), an image forming optical system 37 that condenses image lights subjected to raster deflection (scanning) by the deflecting unit 35 on the photosensitive drums 22-2, 23-2, and 24-2 of the second to the fourth image forming units 22 to 24 under predetermined conditions regardless of an angle of deflection, and an exposure light shaping optical system 39 that guides image lights from the respective light sources 33-1 to 33-3 to the deflecting unit 35 under predetermined conditions.

The deflecting unit 35 has a rotatable reflection element, which is fixed to a shaft of the motor. The deflecting unit 35 is rotated at predetermined speed (number of revolutions) for raster scanning (deflection). The number of reflection surfaces provided in the reflection element and the number of revolutions thereof are defined according to a request for output, that is, resolution, output speed, and the like required of the copying apparatus (the image forming apparatus) 1. As examples of characteristics of a shape of a reflecting member 35-1 of the deflecting unit 35, the number of reflection surfaces is eight, thickness thereof is 6 mm, and a diameter of an inscribed circle thereof is 40 mm.

The image forming optical system 37 includes, in positions in the longitudinal directions of the photosensitive drums 22-2, 23-2, and 24-2, that is, in a direction perpendicular to a direction in which paper is conveyed (a direction in which the photosensitive drum is rotated), at least (long slender) lenses 37-1 and 37-2 (extending in the longitudinal directions) to which different convergent properties are given in association with positions (on the photosensitive drum) depending on an angle of deflection, which is a swing angle, of image light subjected to raster scanning by the deflecting unit 35 that is caused when the image light is subjected to raster deflection.

The image forming optical system 37 also includes various optical elements (e.g., a mirror(s) and a filter(s)) for guiding the image light subjected to raster scanning by the deflecting unit 35 to the respective photosensitive drums 22-2, 23-2, and 24-2 of the second to the fourth image forming units 22 to 24. The lenses 37-1 and/or 37-2 are common to image lights of three groups of C, M, and Y (for color) that control hues. Thus, even when warp or the like peculiar to any one of or each of the lenses is present, an influence of the warp is reflected on all the image lights (of three groups) in the same manner. Similarly, even when arbitrary (all) lens surfaces are arranged to be inclined (with respect to a design value) because of a shape error or the like of any one of or each of the lenses, an influence of the inclination is reflected on all the image lights (of the three groups). The lenses 37-1 and/or 37-2 may be replaced with a mirror(s) having a similar curved surface by optimizing types and shapes of the optical elements and using a combination of arrangements.

The exposure light shaping optical system 39 shapes image lights from the respective light sources 33-1 to 33-3 to have a sectional beam shape satisfying predetermined conditions (to be condensed) when the image lights are subjected to raster scanning by the deflecting unit 35 and condensed in predetermined positions in the longitudinal directions of the respective photosensitive drums 22-2, 23-2, and 24-2 in the image forming optical system 37. The exposure light shaping optical system 39 includes various optical elements represented by, for example, a condenser(s), a mirror(s), and an aperture stop(s).

In the second exposing unit 31, image lights of three groups irradiated are supplied from the exposure light shaping optical system 39 (the light sources 33-1, 33-2, and 33-3) to the deflecting unit 35 according to the well-known under-fill (under illumination) system. It is possible to collectively deflect (continuously reflect) the image lights of the three groups on an arbitrary reflection surface of the reflection surfaces 35-1 of the deflecting unit 35 by using the under-fill (under illumination) system. When the image lights of the three groups correspond to C, M, and Y components for a color image, compared with the case in which deflecting units are provided independently, it is unnecessary to take into account an influence of color drift due to individual differences of the deflecting units.

As it is evident from FIG. 6, in the second exposing unit 31, since the image lights of the three groups correspond to the C, M, and Y components for a color image, when the over illumination system for BK shown in FIG. 3 is used, it is difficult to apply the guiding of image light (incident light), which travels to the reflection surfaces, from generally the center of the reflection surfaces and the main scanning direction of the lens of the focusing optical system to all the image light because large asymmetry occurs in a beam width and an amount of light of emitted light. On the other hand, it is possible to guide the image light to the reflection surfaces from a direction not overlapping an optical path of the emitted light (in a plane direction). Thus, there is a significant advantage compared with the adoption of the over illumination system.

Predetermined intervals corresponding to positions where the first to the fourth image forming units 21 to 24 are arranged (substantially equal intervals or intervals of integer times on the belt surface of the intermediate transfer belt 13) are given to image lights emitted from the first exposing unit 3 and the second exposing unit 31. For example, intervals of three image lights of C, M, and Y emitted from the second exposing unit 31 are defined as integer times (one time) as large as a circumference (a rotation pitch of the driving roller 15) calculated by adding up a diameter of the driving roller 15 and thickness of the intermediate transfer belt 13. Intervals of image light emitted from the first exposing unit (for exposure of BK image light on the first image forming unit 21) are defined as two times (integer times) as large as a circumference (a rotation pitch of the driving roller 15) calculated by adding up the intervals of the image light closest to the first image forming unit 21 among the image lights from the second exposing unit 31 adjacent thereto, the diameter of the driving roller 15, and the thickness of the intermediate transfer belt 13. This means that, even if there is eccentricity or the like in the driving roller 15, it is possible to make an influence of the eccentricity such as color drift less conspicuous because the same period is given when images are formed in the first to the fourth image forming units 21 to 24.

Concerning the first exposing unit 3 explained with reference to FIGS. 2 and 3, at the time of output of a non-color image, that is, at the time of output of a monochromatic BK image, it is also possible to increase speed of image output by simply setting the number of revolutions of the reflection surfaces 3-3-1 of the deflecting unit 3-3 to β (β>1) times as large as the defined number of revolutions and setting an image frequency of a BK image (a laser driving frequency applied to a laser element of the light source 3-1) and sub-scanning direction speed (moving speed of the outer peripheral surface of the photosensitive drum 21-2, moving speed of the belt surface of the intermediate transfer belt 13, and conveyance speed at the time when the paper P is conveyed) to β times as large as the defined image frequency and sub-scanning direction speed, respectively.

FIG. 7 shows a relation between a spatial frequency and response of perception of eyes (of a human, that is, a user) for explaining one of advantages of using the first exposing unit 3 explained with reference to FIGS. 3 and 4 and the second exposing unit 31 explained with reference to FIGS. 5 and 6.

As it is evident from FIG. 7, a spatial frequency felt by the eyes (of the human, that is, the user) for light and shade (black and white) extends to a higher region than a spatial frequency for color components (colors). Therefore, when three colors (C, M, and Y) of a chromatic color provided from the second exposing unit 31 and a BK image provided from the first exposing unit 3 are superimposed to obtain a full-color image, if resolution of the BK image is improved, the same effect as improvement of resolution in the full-color image is expected.

Therefore, concerning the first exposing unit 3 explained with reference to FIGS. 2 and 3, at the time of output of a color image, it is possible to increase resolution to γ (γ>1, γ may be identical with β) times as high by setting the number of revolutions of the reflection surfaces 3-3-1 of the deflecting unit 3-3 to γ times and setting an image frequency of a BK image (a laser driving frequency applied to the laser element of the light source 3-1) to γ² times as large as conditions for obtaining the same resolution as resolution of Y, M, and C.

When the number of reflection surfaces 3-3-1 of the deflecting unit 3-5 of the first exposing unit 3 for BK is δ times as large as the number of reflection surfaces 35-1 of the deflecting unit 35 of the second exposing unit 31 and a (total) f value of the image forming optical system 3-5 of the first exposing unit 3 is ε times as large as a (total) f value of the image forming optical system 37 of the second exposing unit 31, it is possible to improve resolution to γ times as large as the defined resolution by setting the number of revolutions of the reflection surfaces 3-3-1 of the deflecting unit 3-3 for a BK image (the first exposing unit) to γ/δ, setting an image frequency of BK to γ/ε, and setting sub-scanning direction resolution to γ times as large as the defined sub-scanning direction resolution. Concerning the main scanning direction (image light), it is possible to cope with improvement of resolution by changing density of an image in a position of (light) in one dot, that is, in the main scanning direction to γ times as large as the defined density.

As explained above, according to the image forming apparatus of the invention, it is possible to reduce time required until a monochromatic image output frequently used for image formation is outputted. Moreover, the number of output sheets per unit time in outputting a color image is equivalent to that of the monochromatic image output. Thus, for an exposure system used for the monochromatic image output frequently used for image formation, it is possible to secure durability equivalent to that of an exposure system for a color image. At the time of output of a non-color image, that is, at the time of output of a monochromatic BK image, it is possible to improve output resolution. Moreover, at the time of output of a non-color image, that is, at the time of output of a monochromatic BK image, it is possible to increase speed of image output (number of output sheets/unit time).

Since the first exposure unit is an exposure unit for BK (black) and the second exposure unit is an exposure unit for C, M, and Y subjected to color separation in accordance with a subtractive process, it is possible to easily classify a monochromatic BK dedicated machine and a full-color machine according to whether one exposing unit or two exposing units are provided for substantially an identical image forming unit. Thus, it is possible to reduce cost for preparing a wide variety of image forming apparatuses.

On the other hand, since image lights of three groups of C, M, and Y are aggregated in the second exposing unit, a factor of causing specific (peculiar) color drift only in an image of an arbitrary color component is eliminated. Further, by improving resolution of a BK image independently, resolution of a color image is also improved (in appearance).

Moreover, image lights (for color) of three groups of C, M, and Y controlling hues are guided to the image forming units (the photosensitive drums) by the identical exposing unit (the image forming optical system). Thus, since attachment errors of a lens(es), a mirror(s), and/or a filter(s) due to warp of lenses and shape accuracy of housings (of the exposing units) are equalized, occurrence of color drift and hue drift is controlled.

Since image light (for color) of three groups of C, M, and Y determining hues is deflected by the single deflecting unit, while image light is deflected (used for scanning in the main scanning direction once) by the first exposing unit for a BK image, it is also possible to control color drift in the main scanning direction due to speed deviation of the deflecting unit by controlling fluctuation in rotation of the motor of the deflecting unit (of the second exposing unit). Concerning the reflection surfaces of the reflecting member of the deflecting unit of the second exposing unit, since flatness (e.g., concave entirely or convex entirely) is set to reduce a relative difference (whereas an absolute value is increased on the reflection surfaces of the reflecting member of the deflecting unit of the first exposing unit), it is possible to prevent hue drift from occurring because of positional deviation (of image light on an image surface) in the main scanning direction.

Moreover, concerning scanning line bending between image light focused by the second exposing unit (C, M, and Y) and image light focused by the first exposing unit (BK), it is possible to make the scanning line bending less conspicuous visually according to the effect of optimization of bending of a scanning line of a BK image with high resolution even if the scanning line bending is corrected by image data in the first exposing unit that provides a BK image with a high (recognizable) spatial frequency. Since the exposing unit for BK is separated from the exposing unit for color and independently provided, a size of a housing of the exposing unit for BK is reduced and a shape error in forming the housing is reduced. Thus, an image quality of a BK image required of high resolution is improved.

Advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a first toner image generating unit configured to generate a latent image corresponding to first image light supplied in association with one of color components;
a second toner image generating unit configured to generate a latent image corresponding to second image light supplied in association with one of the color components different from the first image light supplied to the first toner image generating unit;
a third toner image generating unit configured to generate a latent image corresponding to third image light supplied in association with one of the color components different from the first and the second image lights supplied to the first toner image generating unit and the second toner image generating unit;
a first exposing unit configured to continuously deflect the first image light in one direction toward the first toner image generating unit;
a second exposing unit configured to continuously deflect the second image light and the third image light in one direction toward the second toner image generating unit and the third toner image generating unit;
a first developing unit configured to visualize, with a toner of a first color, a latent image formed on the first toner image generating unit by the first image light deflected by the first exposing unit;
a second developing unit configured to visualize, with a toner of a second color, a latent image formed on the second toner image generating unit by the second image light deflected by the second exposing unit; and
a third developing unit configured to visualize, with a toner of a third color, a latent image formed on the third toner image generating unit by the third image light deflected by the second exposing unit.

2. An image forming apparatus according to claim 1, wherein
the first exposing unit is an exposing unit of an over illumination system and the second exposing unit is an exposing unit of an under illumination system, and
an inscribed circle radius of reflection surfaces of a reflecting member of a deflecting unit included in the first exposing unit is smaller than an inscribed circle radius of reflection surfaces of a reflecting member of a deflecting unit included in the second exposing unit.

3. An image forming apparatus according to claim 2, wherein the reflecting member of the deflecting unit included in the first exposing unit is rotated at higher speed at the time of image formation than the reflecting member of the deflecting unit included in the second exposing unit.

4. An image forming apparatus according to claim 2, further comprising: an intermediate transfer member onto which the first to the third toner images obtained by visualizing the latent images, which are generated in the respective first to third toner image generating units, with the first to the third developing units are sequentially transferred.

5. An image forming apparatus according to claim 4, wherein intervals among image lights emitted from the first exposing unit and the second exposing unit are integer times as large as a circumference calculated by adding up a diameter of a driving mechanism for turning the intermediate transfer belt and thickness of the intermediate transfer belt.

6. An image forming apparatus according to claim 1, wherein thickness and/or weight of a reflecting member of a deflecting unit included in the first exposing unit are smaller than thickness and/or weight of a reflecting member of a deflecting unit included in the second exposing unit.

7. An image forming apparatus according to claim 1, wherein the second exposing unit can be removed.

8. A color image forming apparatus comprising:
a first latent image holding member configured to hold a latent image corresponding to first image light supplied in association with one of color components;
a second latent image holding member configured to generate a latent image corresponding to second image light supplied in association with one of the color components different from the first image light supplied to the first latent image holding member;
a third latent image holding member configured to generate a latent image corresponding to third image light supplied in association with one of the color components different from both the first image light supplied to the first latent image holding member and the second image light supplied to the second latent image holding member;
a first exposing unit configured to continuously deflect the first image light in one direction toward the first latent image holding member, the first exposing unit deflecting the first image light in the one direction according to an over illumination system;
a second exposing unit configured to continuously deflect the second image light and the third image light in one direction toward the second latent image holding member and the third latent image holding member, the second exposing unit deflecting the second and the third image lights in the one direction according to an under illumination system;
a first developing unit configured to visualize, with a toner of a first color, a latent image formed on the first holding member by the first image light deflected by the first exposing unit;
a second developing unit configured to visualize, with a toner of a second color, a latent image formed on the second holding member by the second image light deflected by the second exposing unit; and
a third developing unit configured to visualize, with a toner of a third color, a latent image formed on the third holding member by the third image light deflected by the second exposing unit.

9. A color image forming apparatus according to claim 8, wherein an inscribed circle radius of reflection surfaces of a reflecting member of a deflecting unit included in the first exposing unit is smaller than an inscribed circle radius of reflection surfaces of a reflecting member of a deflecting unit included in the second exposing unit.

10. A color image forming apparatus according to claim 9, wherein the reflecting member of the deflecting unit included in the first exposing unit is rotated at higher speed at the time of image formation in which only the first image light is provided than the reflecting member of the deflecting unit included in the second exposing unit at the time of image formation involving the second and the third image lights.

11. An image forming apparatus according to claim 9, further comprising: an intermediate transfer member onto which the first to the third toner images obtained by visualizing the latent images, which are generated in the respective first to third latent image holding members, with the first to the third developing units are sequentially transferred.

12. An image forming apparatus according to claim 1, wherein intervals among image lights emitted from the first exposing unit and the second exposing unit are integer times as large as a circumference calculated by adding up a diameter of a driving mechanism for turning an intermediate transfer belt and thickness of the intermediate transfer belt.

13. An image forming apparatus according to claim 12, wherein intervals between image light emitted from the first exposing unit and image light adjacent to the image light emitted from the first exposing unit among image lights emitted from the second exposing unit are twice as large as a circumference obtained by adding up the diameter of the driving mechanism for turning the intermediate transfer belt and the thickness of the intermediate transfer belt.

14. An image forming apparatus according to claim 8, wherein the second exposing unit can be removed.

15. An image forming apparatus according to claim 8, wherein the first exposing unit can change linearity of the first image light along the one direction of the first image light.
